(19) United States
(12) Patent Application Publication
(10) Pub. No.: US 2026/0139696 A1
(43) Pub. Date: May 21, 2026

(54) CONNECTION CLIP FOR A TENT

(71) Applicant: Ningbo Dongrun Mining Co., Ltd., Ningbo City Zhejiang Province (CN)

(72) Inventor: Libo Song, Ningbo City Zhejiang Province (CN)

(21) Appl. No.: 19/446,815

(22) Filed: Jan. 12, 2026

(30) Foreign Application Priority Data
Dec. 5, 2025 (CN) 202522588608.7

(51) Int. Cl. F16B 2/10; E04H 15/34

(52) U.S. Cl. CPC F16B 2/10; E04H 15/34

(57) ABSTRACT

A connection clip for a tent, comprising a first clamping body and a second clamping body. When the first clamping body and the second clamping body engage, a first locking portion and a second locking portion are assembled into a locking assembly. A locking member is displaced along a first direction to cause the locking assembly to be at least partially accommodated in a locking cavity, thereby achieving a fixed connection between the two clamping bodies; the locking member is opened when being displaced in a reverse direction. The connection clip is adaptable for use with columnar members of different diameters, features reliable locking, and is convenient to operate.

### TECHNICAL FIELD

The present invention relates to the technical field of outdoor products, and more particularly to a connection clip for a tent.

### BACKGROUND

As the core shelter facility for outdoor camping, emergency rescue, and temporary activities, the structural stability of a tent completely depends on the connection and fixation of columnar members such as main pillars and crossbars. As a key component for connecting columnar members, a connection clip needs to satisfy the dual requirements of stable clamping of multiple types of columnar members and anti-loosening in outdoor environments: it must not only reliably connect the main pillar of the tent with the crossbar, brace rod, and the like to form a three-dimensional support frame capable of withstanding external impacts generated by outdoor wind and human activities; but also needs to be compatible with columnar members of different diameters (e.g., a main pillar with a diameter of 25 mm and a crossbar with a diameter of 18 mm), while satisfying the needs for rapid assembly and detachment (to cope with changeable outdoor weather or emergency relocation needs). Its structural design directly determines the assembly efficiency and safety of the tent.

The conventional structures of existing connection clips for tents mostly adopt a "fixed jaw plus simple locking" design, and the core defects are concentrated on adaptability, reliability, and convenience, making it difficult to meet complex outdoor needs.

First, the clamping portions of existing connection clips are mostly arc-shaped or u-shaped structures of fixed sizes, and the gap of the jaw cannot be adjusted: if used for clamping a columnar member with a diameter smaller than the jaw, an excessive gap will cause the columnar member to shake, making the tent frame prone to deformation; if used for a columnar member with a diameter larger than the jaw, the clip cannot engage. It is necessary to provide multiple sets of specialized connection clips for columnar members of different specifications, which increases the carrying weight and cost. Especially when multi-specification tents need to be built for multi-person camping, accessory management is cumbersome, and mismatching or loss is likely to occur.

Second, existing connection clips are mainly of an elastic buckle type, which relies on the deformation and engagement locking of plastic buckles. In an outdoor low-temperature environment, the plastic buckles are prone to brittle fracture, or the buckles may disengage due to wind vibration, causing the columnar member to loosen and lead to local collapse of the tent. In addition, the locking and clamping of some connection clips are independent of each other, and after locking, the clamping portion may still experience micro-displacements due to external forces, further weakening the clamping stability.

Third, if the jaw gap needs to be fine-tuned in existing connection clips (for a few adjustable models), the locking structure must be loosened first, the position of the clamping block must be adjusted separately, and then re-locked, which involves cumbersome operation steps. Furthermore, there is a lack of precise guidance during the adjustment process, and the clamping portion is prone to deviation, resulting in a loose abutment with the columnar member. During outdoor construction, personnel often need to perform one-handed operation or work in an environment with insufficient light. Complex operation procedures will significantly prolong the assembly time. If sudden rain, strong winds, or other weather conditions are encountered, the tent construction may fail due to the failure to complete the locking in time.

The summary of the present invention is used to introduce concepts in a brief form, and these concepts will be described in detail in the detailed embodiment later. The summary of the present invention is not intended to identify key features or essential features of the claimed technical solution, nor is it intended to be used to limit the scope of the claimed technical solution.

In order to overcome the deficiencies of the prior art, the present invention provides a connection clip for a tent.

To achieve the above objective, the present invention adopts the following technical solution:

A connection clip for a tent, comprising:

a first clamping body, configured to have an opening; and

a second clamping body, the second clamping body movably disposed relative to the first clamping body and surrounding to form a closed clamping cavity when engaged with each other.

Wherein, a first clamping portion is disposed on the clamping cavity of the first clamping body, a clamping block is movably disposed on the second clamping body, and a second clamping portion is disposed on the clamping block and is movably disposed to move toward or away from the first clamping portion along a first direction;

a first locking portion is disposed on the first clamping body, a second locking portion and a locking member are disposed on the second clamping body, the locking member is connected to the clamping block and is movably disposed relative to the second clamping body along the first direction, and a locking cavity is disposed on the locking member;

When the first clamping body and the second clamping body engage, the first locking portion and the second locking portion are assembled into a locking assembly, and the locking member displaces along the first direction such that the locking assembly is at least partially accommodated in the locking cavity, so as to fixedly connect the first clamping body and the second clamping body and cause the first clamping portion and the second clamping portion to clamp a columnar member positioned in the clamping cavity; the locking member displaces away from the locking cavity along the first direction to cause the locking assembly to disengage from the locking cavity, and the second clamping portion is opened relative to the first clamping portion.

The beneficial effects of the present invention are as follows:

The clamping block on the second clamping body can drive the second clamping portion to move toward or away from the first clamping portion along the first direction. Without replacing specialized connection clips, the gap between the clamping portions can be adjusted to fit columnar members of different diameters (e.g., a main pillar of 25 mm and a crossbar of 18 mm): for thin columnar members, the gap can be reduced to achieve a tight abutment, avoiding frame deformation caused by shaking of the members; for thick columnar members, the gap can be enlarged to ensure smooth engagement, completely solving the problems of existing fixed jaws being either loose or unable to engage. Users do not need to carry multiple sets of connection clips of different specifications, which not only reduces the carrying weight for outdoor use and lowers accessory management costs, but also avoids the risk of mismatching or loss, thereby meeting the requirements of tent assembly in various scenarios such as solo camping and group activities.

When the first clamping body and the second clamping body engage, the locking assembly formed by the assembly of the first locking portion and the second locking portion can be accommodated in the locking cavity, forming a rigid locking structure: compared to existing elastic buckles (which are prone to brittle fracture at low temperatures and disengagement due to vibration), the rigid locking can withstand outdoor wind impacts and vibrations during vehicle transportation, avoiding loosening of columnar members or tent collapse caused by locking failure. At the same time, the linkage design of the locking member and the clamping block drives the clamping portions to tighten synchronously during the locking process, avoiding the displacement of the clamping portions caused by independent locking and clamping, thereby further enhancing the clamping stability.

Existing connection clips require multiple steps to perform locking, whereas in the present invention, the locking member is directly connected to the clamping block. When the locking member is moved along the first direction, gap adjustment of the clamping portions and clamping body locking can be completed synchronously: pushing the locking member toward the locking assembly can cause the second clamping portion to move toward the first clamping portion to clamp the columnar member, and can also incorporate the locking assembly into the locking cavity to complete the fixation; moving the locking member in the opposite direction can synchronously unlock and open the clamping portions. The entire process requires only one step of operation without separately adjusting the position of the clamping block. It is particularly suitable for one-handed operation in outdoor settings or low-light scenarios, which can shorten the tent assembly time, avoid assembly failure due to cumbersome operations in weather conditions such as sudden rain or strong winds, and enhance emergency response efficiency. Other camping equipment, such as a barbecue grill, can also be quickly installed onto the tent.

### BRIEF DESCRIPTION OF THE DRAWINGS

The accompanying drawings, which constitute a part of this application, are used to provide a further understanding of the application, so that other features, objectives, and advantages of the application become more apparent. The schematic embodiment drawings of the application and the descriptions thereof are used to explain the application and do not constitute an improper limitation of the application.

In addition, throughout the drawings, the same or similar reference numerals represent the same or similar elements. It should be understood that the drawings are schematic, and components and elements are not necessarily drawn to scale.

FIG. 1 is a schematic view of the clamping cavity of a connection clip for a tent in a closed state according to an embodiment of the present invention.

FIG. 2 is a schematic view of the clamping cavity of the connection clip for a tent shown in FIG. 1 in an open state.

FIG. 3 is a cross-sectional view of the connection clip for a tent shown in FIG. 1.

FIG. 4 is a schematic view of a connection clip for a tent according to another embodiment of the present invention.

FIG. 5 is a cross-sectional view of the connection clip for a tent shown in FIG. 4.

FIG. 6 is a schematic view of a connection clip for a tent according to yet another embodiment of the present invention.

Reference numerals in the drawings are as follows: 10, first clamping body; 101, first locking portion; 102, first clamping portion; 103, third connecting portion; 104, first clearance slot; 105, first connecting portion; 106, meshing portion; 1061, first inclined slot; 20, second clamping body; 201, second locking portion; 202, second connecting portion; 203, second clearance slot; 204, mounting slot; 205, guiding groove; 206, meshing slot; 2061, second inclined slot; 1a, clamping cavity; 30, locking member; 301, hand-held portion; 302, groove; 30b, locking cavity; 40, clamping block; 401, second clamping portion; 402, guiding block; 50, connecting member; 60, guiding member; 60c, guiding hole; 70, mortise; 80, tenon.

### DESCRIPTION OF THE EMBODIMENTS

Embodiments of the present disclosure will be described in more detail below with reference to the accompanying drawings. While certain embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments of the present disclosure are for schematic purposes only and are not intended to limit the protection scope of the present disclosure.

The present disclosure will be described in detail below with reference to the accompanying drawings and in combination with embodiments.

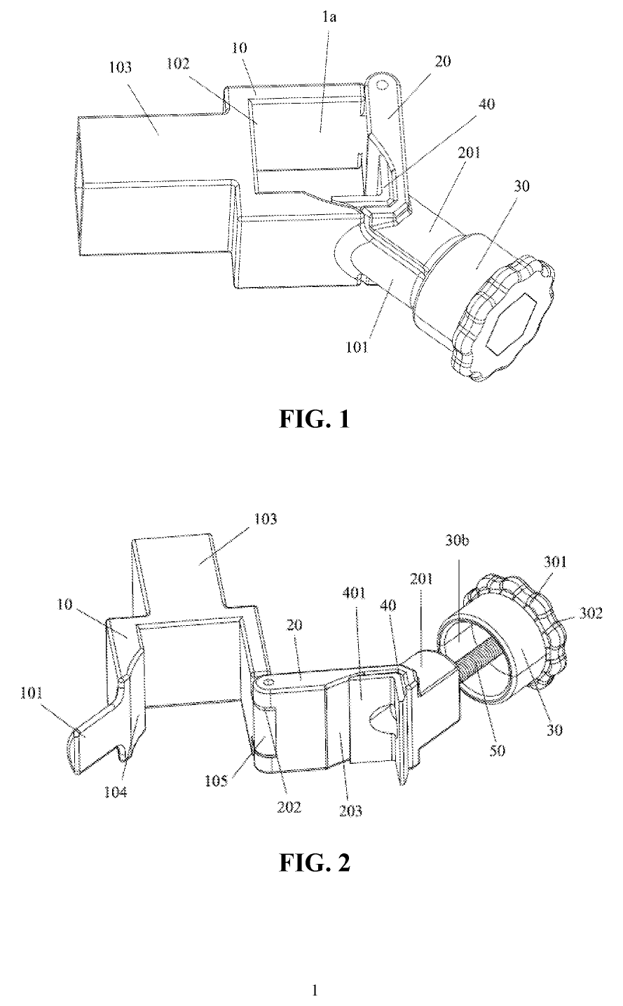

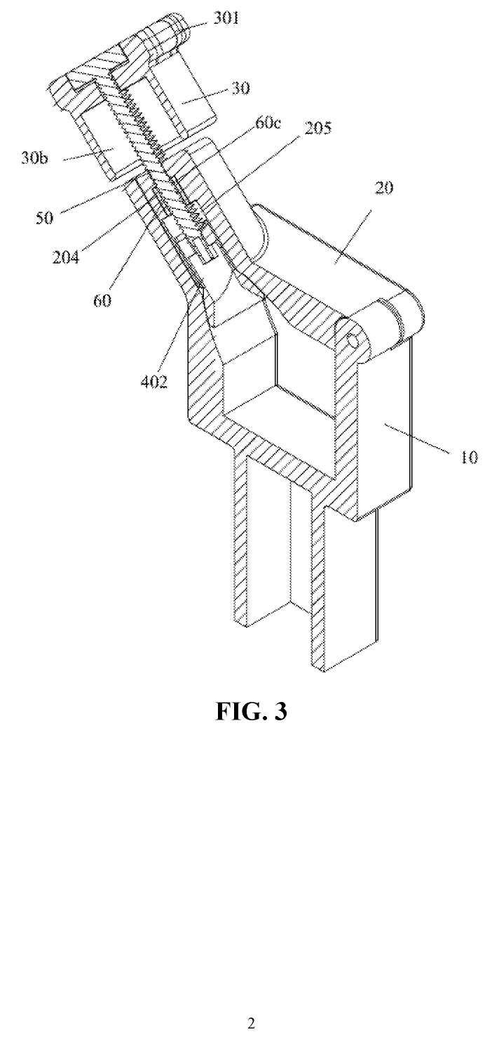

As shown in FIGS. 1 to 3, a connection clip for a tent, used for forming a docking with a columnar member (such as a tent main pillar, not shown in the drawings), includes a first clamping body 10 and a second clamping body 20. The first clamping body 10 is a rectangular frame structure having a certain height, and an opening is disposed on a side wall of the first clamping body 10. The second clamping body 20 is capable of opening relative to the first clamping body 10 and surrounding to form a closed clamping cavity 1a when engaging with the first clamping body 10. The second clamping body 20 is preferred to be a linear structure, and the size of the second clamping body 20 is fit with the internal space of the first clamping body 10 to ensure a tight abutment during engagement. In other embodiments, the first clamping body 10 may also be a u-shaped member or a semi-circular member, and the second clamping body 20 may correspondingly be an arcuate member or a linear member, or the first clamping body 10 and the second clamping body 20 may have other shapes; the shapes of the two are not strictly limited, as long as it is ensured that the two can clamp and install the columnar member (not shown in the drawings) in the clamping cavity 1a after engaging with each other, so that the connection clip can be conveniently and quickly connected to the columnar member.

Specifically, a first connecting portion 105 is disposed on one end of the opening of the first clamping body 10, and a second connecting portion 202 is disposed on one end of the second clamping body 20. The first connecting portion 105 is a cylindrical structure protruding from the one end of the opening, and the second connecting portion 202 is a cylindrical groove structure disposed on the one end of the second clamping body 20. The groove shape of the second connecting portion 202 corresponds to the cylindrical shape of the first connecting portion 105. A first connecting hole is disposed on the first connecting portion 105, and a second connecting hole is disposed on the second connecting portion 202. When the first connecting portion 105 is positioned within the second connecting portion 202, a connecting shaft passes through the first connecting hole and the second connecting hole to form a rotatable connection between the first clamping body 10 and the second clamping body 20. The second clamping body 20 pivots about the connecting shaft in a direction parallel to the top surface of the first clamping body 10. When the second clamping body 20 rotates out from the opening, it is convenient to place the connected columnar member into the clamping cavity 1a or take it out from the clamping cavity 1a. When the second clamping body 20 rotates into the opening, the clamping cavity 1a is closed to facilitate fixing the columnar member.

In some other embodiments, the fixed articulation between the second clamping body 20 and the first clamping body 10 may also be changed to a detachable articulation. That is, the first connecting hole on the first connecting portion 105 is configured to have an opening on a side surface thereof to form an open shaft slot, and a shaft post is correspondingly disposed on the second connecting portion 202. By snap-fitting the shaft post into the shaft slot, the rotatable movement of the second clamping body 20 relative to the first clamping body 10 is achieved, and the second clamping body 20 is detachably disposed relative to the first clamping body 10.

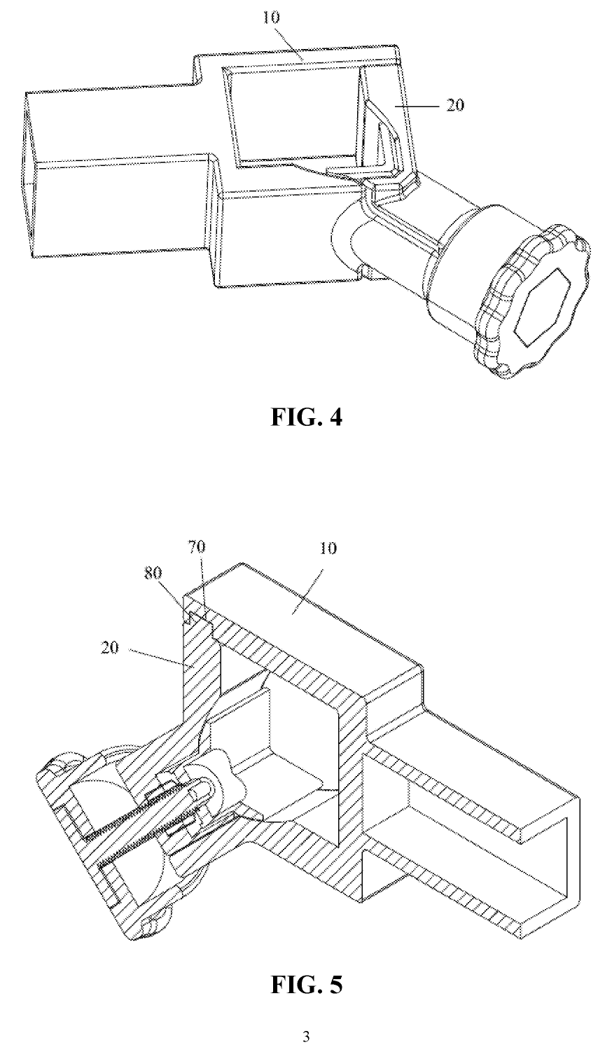

As shown in FIGS. 4 to 5, in other embodiments, a mortise-and-tenon detachable connection may also be formed between the second clamping body 20 and the first clamping body 10. That is, a tenon 80 and a mortise 70 are correspondingly disposed on the two, and the mortise-and-tenon assembly direction between the two is configured to match a locking direction of the locking member 30, such that the second clamping body 20 is detachably installed on the first clamping body 10 and the first clamping body 10 and the second clamping body 20 are completely locked by the locking member 30.

In short, the second clamping body 20 is an openable movable setting relative to the first clamping body 10. After being opened or closed, the two can be locked in one or two dimensions in three dimensions, while being unlocked and movable in the remaining two or one dimension, and then locked by an additionally provided locking structure, thereby completely locking the connection clip. For example, as shown in FIG. 2, the second clamping body 20 is articulated on the first clamping body 10. Therefore, when the first clamping body 10 and the second clamping body 20 engage with each other, the second clamping body 20 is locked in a vertical direction due to the articulated structure and abuts against and locks with each other in a forward direction of the rotation direction, while being openable in a reverse direction of the rotation direction. Then, the movement of the second clamping body 20 in the reverse direction of the rotation direction is locked by the locking member 30, thereby achieving complete locking of the first clamping body 10 and the second clamping body 20.

The first locking portion 101 is disposed on the first clamping body 10, and the second locking portion 201 is disposed on the second clamping body 20. The first locking portion 101 and the first connecting portion 105 are respectively disposed on two ends of the opening, and the second locking portion 201 and the second connecting portion 202 are respectively disposed on two ends of the second clamping body 20. The first locking portion 101 is a first cylindrical portion protruding from the first clamping body 10, and the second locking portion 201 is a second cylindrical portion protruding from the second clamping body 20. When the first clamping body 10 and the second clamping body 20 engage, the first locking portion 101 and the second locking portion 201 are assembled into a locking assembly, and the locking assembly is on the same straight line as a diagonal of the clamping cavity 1a.

The locking member 30 is disposed on the second clamping body 20, the locking member 30 has a sleeve-type structure, and the locking cavity 30b is disposed on the locking member 30. The locking member is capable of moving along a diagonal direction of the clamping cavity 1a such that the locking cavity 30b is sleeved on the locking assembly to be fixedly connected to the first clamping body 10 and the second clamping body 20.

Specifically, a cross section of the first locking portion 101 is a quarter-circle structure, and a cross section of the second locking portion 201 is a three-quarter-circle structure. When the second clamping body 20 rotates into the opening about the connecting shaft, a rectangular side wall of the second locking portion 201 abuts against a rectangular side wall of the first locking portion 101 to form a locking assembly, and a cross section of the locking assembly is a circular structure. The locking member 30 is also a cylindrical structure, and a shape of the locking cavity 30b corresponds to the shape of the locking assembly.

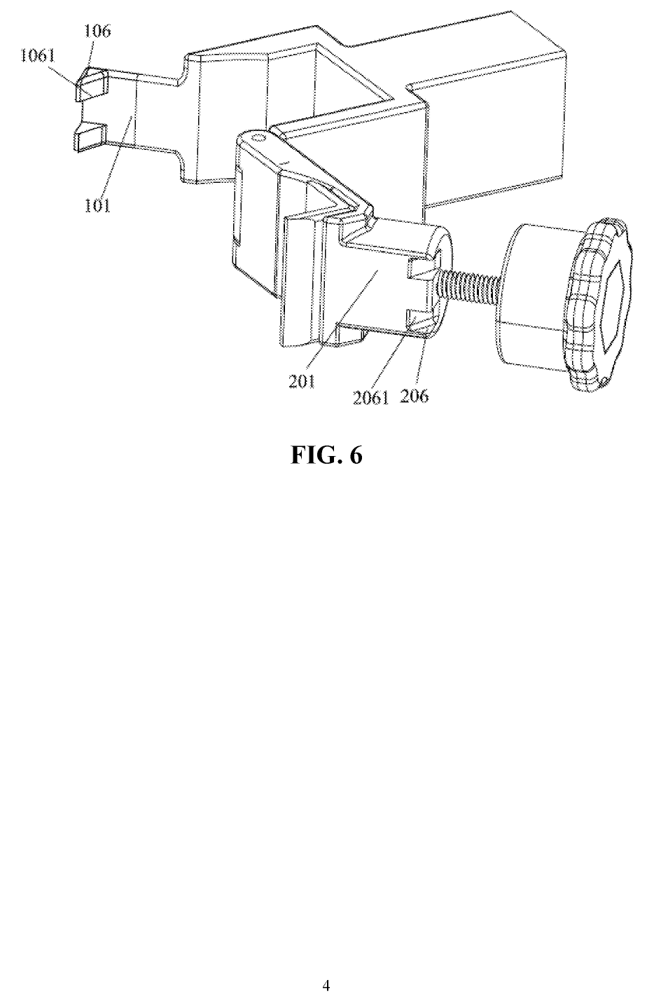

As shown in FIG. 6, in another preferred embodiment, a meshing portion 106 is protrudingly disposed on the first locking portion 101, and a meshing slot 206 is correspondingly disposed on the second locking portion 201. When the first locking portion 101 and the second locking portion 201 abut to form an assembly, the meshing portion 106 is embedded into the meshing slot 206 to position a preliminary assembly of the first locking portion 101 and the second locking portion 201 without affecting subsequent locking of the locking assembly by the locking member 30. Further preferably, a first inclined slot 1061 is disposed on a side wall of the meshing portion 106, and a corresponding second inclined slot 2061 is disposed on an inner wall of the meshing slot 206, such that when the meshing portion 106 is embedded into the meshing slot 206, a side wall of the first inclined slot 1061 abuts against a side wall of the second inclined slot 2061 to guide the meshing portion 106, thereby facilitating accurate embedding of the meshing portion 106 into the meshing slot 206. At the same time, such a setting of the inclined slots can also increase a frictional force between the meshing portion 106 and the meshing slot 206 to a certain extent, improving the stability of the preliminary assembly.

Wherein, the locking of the first clamping body 10 and the second clamping body 20 by the locking member 30 is achieved based on sleeving the first locking portion 101 of the first clamping body 10 and the second locking portion 201 of the second clamping body 20 therein. When the locking member 30 rotates in place, left and right side walls of the locking member 30 respectively lock the first locking portion 101 and the second locking portion 201. Therefore, based on the present embodiment, the locking member 30 can be separated from the hand-held portion 301. The hand-held portion 301 is disposed on one end of the locking assembly for driving the connecting member 50 to rotate relative to a nut in the second locking portion 201 to push the clamping block 40 to lock or unlock. The locking member 30 can be moved forward or backward along the first direction to sleeve the first locking portion 101 and the second locking portion 201 therein, or the locking member 30 can be detached and separated from the first locking portion 101 and the second locking portion 201.

The shape of the locking cavity 30b in the locking member 30 is fit with the locking assembly formed by the abutment of the second locking portion 201 and the first locking portion 101. When the locking member 30 moves along the diagonal direction (i.e., the first direction) of the first clamping body 10 and the second clamping body 20, the locking assembly can be accurately accommodated therein. Such a design makes the locking process more stable and reliable, further enhancing the fixing effect of the connection clip on the columnar member.

A plurality of grooves 302 is disposed on a side wall of the hand-held portion 301 to increase the frictional force of the hand-held portion 301, making the rotation of a threaded rod more convenient.

More specifically, the second locking portion 201 is a hollow structure, a mounting slot 204 is disposed on the second locking portion 201, a guiding member 60 is fixedly connected in the mounting slot 204, the connecting member 50 is fixedly connected on the locking member 30, and a guiding hole 60c is disposed on the guiding member 60. Preferably, the guiding member 60 is a nut, the connecting member 50 is a threaded rod, and the guiding hole 60c is a threaded hole on the nut. The threaded rod passes through the threaded hole, such that the nut and the threaded rod form a fit through threads. When the second clamping portion 401 enters the opening of the first clamping body 10 to form the clamping cavity 1a, the first locking portion 101 and the second locking portion 201 abut to form the locking assembly. Rotating the locking member 30 causes the threaded rod to cooperate with the threaded hole to drive the locking member 30 to move toward the clamping cavity 1a along the diagonal direction of the clamping cavity 1a. The locking cavity 30b is sleeved on the locking assembly to fix the locking assembly, thereby fixing the first clamping body 10 and the second clamping body 20. The cooperation between the threaded rod and the nut prevents the locking member 30 from disengaging from the locking assembly on its own after being sleeved on the locking assembly.

Further, the other end of the connecting member 50 is rotatably connected to a clamping block 40. The clamping block 40 is at one corner of the clamping cavity 1a and is a right-angled plate structure. A second clamping portion 401 is disposed on the clamping block 40, and a first clamping portion 102 is disposed on the first clamping body 10. The first clamping portion 102 is the right angle in the clamping cavity 1a disposed opposite the clamping block 40. Since the clamping block 40 is connected to the connecting member 50, when the connecting member 50 drives the locking member 30 to move along the diagonal direction of the clamping cavity 1a, the clamping block 40 is driven to move together in that direction, and the first clamping portion 102 and the second clamping portion 401 clamp a columnar member (not shown in the drawings) positioned in the clamping cavity 1a. Using the cooperative movement of the threaded rod and the nut to drive the clamping block 40 to move can further enhance the clamping force of the clamping block 40 on the columnar member in the clamping cavity 1a and improve the connection and fixing effect on the columnar member.

In actual use, since a size of the columnar member (i.e., the tent main pillar) may have a certain error, or in different assembly scenarios, it is necessary to fine-tune the clamping force between the first clamping portion 102 and the second clamping portion 401. By rotating the locking member 30, the rotation of the threaded rod in the threaded hole can achieve an accurate movement of the locking member 30 along the first direction, thereby driving the clamping block 40 and the second clamping portion 401 to perform a minute position adjustment, such that the first clamping portion 102 and the second clamping portion 401 can better abut against the columnar member, further improving the clamping stability and reliability of the connection clip.

At the same time, such a fine-tuning operation is relatively simple and does not require loosening a locking structure first and then separately adjusting the position of the clamping block 40 as in the prior art, which greatly saves operation time. In an outdoor environment, especially when encountering sudden weather changes, the installation of the connection clip for a tent can be quickly completed.

The clamping block 40 is disposed at a corner of the clamping cavity 1a, such that the clamping block 40 is capable of moving along a diagonal of the clamping cavity 1a, allowing the clamping block 40 to have a maximum travel distance, thereby utilizing the first clamping portion 102 and the second clamping portion 401 to clamp more columnar members of different sizes.

During installation, an operator only needs to engage the first clamping body 10 and the second clamping body 20 onto a columnar member, and then rotates the locking member 30 such that the locking member 30 moves along the diagonal direction of the clamping cavity 1a under threaded cooperation. During the movement, the locking member 30, on one hand, incorporates the locking assembly into the locking cavity 30b to complete the locking between the two clamping bodies; on the other hand, it drives the clamping block 40 to move via the connecting member 50, causing the second clamping portion 401 to move toward the first clamping portion 102 to clamp the columnar member. The entire operation process is simple and fast, and can be easily completed even in a complex outdoor environment.

During disassembly, the locking member 30 is rotated in a reverse direction, the locking assembly disengages from the locking cavity 30b, and the second clamping portion 401 opens relative to the first clamping portion 102, thereby allowing the columnar member to be easily removed. Such a convenient disassembly method significantly improves the efficiency of installation and disassembly of the connection clip, meeting versatile outdoor usage requirements.

The rigid locking structure of the connection clip can effectively withstand external force impacts generated by outdoor wind, human activities, and the like, ensuring stability and safety during use. Meanwhile, the adjustable design of the clamping block 40 enables the connection clip to adapt to columnar members of different diameters, reducing the trouble of carrying multiple sets of specialized connection clips and lowering the usage cost.

Further, a guiding groove 205 is disposed on the second locking portion 201, the guiding groove 205 communicates with the mounting slot 204, a guiding block 402 is disposed on the clamping block 40, the guiding block 402 is positioned in the guiding groove 205, and movement of the guiding block 402 along the guiding groove 205 serves to guide the movement of the clamping block 40, such that when the clamping block 40 moves along the diagonal direction of the clamping cavity 1a, its top surface is always parallel to the top surface of the first clamping body 10.

Such a guiding design further ensures the stability and precision of the movement of the clamping block 40, so that the second clamping portion 401 can maintain good parallelism with the first clamping portion 102 during the movement, thereby applying a clamping force more uniformly to the columnar member. Even if there is a certain unevenness on the surface of the columnar member or a slight tilt during the installation process, the clamping block 40 can adaptively adjust its position under the action of the guiding groove 205 and the guiding block 402 to ensure stable clamping of the columnar member.

In addition, the cooperation between the guiding groove 205 and the guiding block 402 can also effectively prevent the clamping block 40 from shaking or deviating during the movement, avoiding the problem of insecure clamping caused by inaccurate positioning of the clamping block 40. In an outdoor environment, various external forces may be encountered, such as wind blowing and human collision; by utilizing the guiding structure, the connection clip can better handle these situations and always maintain stable clamping of the columnar member.

Moreover, when the rotation of the locking member 30 drives the clamping block 40 to move, the guiding action of the guiding groove 205 and the guiding block 402 reduces the resistance during the movement of the clamping block 40, allowing the operator to more easily complete the adjustment of the gap between the clamping portions and the locking operation of the two clamping bodies. Whether in light-sufficient or low-light conditions, the installation or disassembly work can be completed quickly and accurately, providing great convenience for outdoor users.

A first clearance slot 104 is disposed on a side wall of the first clamping body 10, and a second clearance slot 203 is disposed on a side wall of the second clamping body 20. When the clamping block 40 is positioned within the clamping cavity 1a, side walls of the clamping block 40 are respectively positioned in the first clearance slot 104 and the second clearance slot 203. The design of the first clearance slot 104 and the second clearance slot 203 ensures that the clamping block 40 is not obstructed by the side walls of the first clamping body 10 and the second clamping body 20 during the movement, ensuring smoothness of the movement of the clamping block 40. Meanwhile, these two clearance slots can also play a certain role in limit-stopping, preventing the clamping block 40 from deviating from a predetermined track during the movement, further improving the stability of the movement of the clamping block 40.

In actual use, when the clamping block 40 moves to a limit position, the side walls of the clamping block 40 will abut against ends of the two clearance slots, thereby avoiding structural damage caused by excessive movement of the clamping block 40. Furthermore, the provision of the two clearance slots can increase the contact area between the clamping block 40 and the first clamping body 10 and the second clamping body 20, distributing the pressure on the clamping block 40, reducing local stress concentration, and improving the overall strength and durability of the connection clip.

A third connecting portion 103 is disposed on the side wall of the first clamping body 10, and the third connecting portion 103 is connected to the first clamping body 10 via a steel ring, a pin, or the like, so that other camping equipment (such as a barbecue grill) can be fixed to a pillar of a tent by using the connection clip.

For different types of tent pillars, whether they are columnar members of circular, square or other shapes, as long as their dimensions are within the clamping range of the connection clip, they can be firmly fixed by the connection clip of the present application. In practical applications, the first clamping body 10 and the second clamping body 20 can also be selected from different materials, such as high-strength plastic, aluminum alloy, etc., according to specific requirements, to meet different usage scenarios and load-bearing strength requirements.

What is claimed is:

1. A connection clip for a tent, comprising:
a first clamping body configured to have an opening; and
a second clamping body, the second clamping body movably disposed relative to the first clamping body and surrounding to form a closed clamping cavity when engaged with each other;
wherein a first clamping portion is disposed on the clamping cavity of the first clamping body, a clamping block is movably disposed on the second clamping body, and a second clamping portion is disposed on the clamping block and is movably disposed to move toward or away from the first clamping portion along a first direction;
a first locking portion is disposed on the first clamping body, a second locking portion and a locking member are disposed on the second clamping body, the locking member is connected to the clamping block and is movably disposed along the first direction relative to the second clamping body, and a locking cavity is disposed on the locking member;
when the first clamping body and the second clamping body engage, the first locking portion and the second locking portion are assembled into a locking assembly, and the locking member displaces along the first direction such that the locking assembly is at least partially accommodated in the locking cavity, so as to fixedly connect the first clamping body and the second clamping body and cause the first clamping portion and the second clamping portion to clamp a columnar member positioned in the clamping cavity; the locking member displaces away from the locking cavity to cause the locking assembly to disengage from the locking cavity, and the second clamping portion is opened relative to the first clamping portion.

2. The connection clip for a tent according to claim 1, wherein the second clamping body is capable of moving away from or toward the first clamping body along a second direction, such that the clamping cavity is opened or closed; and
when the locking member moves toward the first clamping body and the second clamping body along the first direction, the locking member locks the second clamping body in the second direction.

3. The connection clip for a tent according to claim 2, wherein a first connecting portion is disposed on the first clamping body, a second connecting portion is disposed on the second clamping body, and the second connecting portion and the first connecting portion are rotatably connected to each other, such that the second clamping body is capable of fully opening the opening after pivoting about a pivot point; and the second direction is parallel to a direction of a top surface of the first clamping body.

4. The connection clip for a tent according to claim 3, wherein the first locking portion and the first connecting portion are respectively disposed on two ends of the opening, and the second locking portion and the second connecting portion are respectively disposed on two ends of the second clamping body.

5. The connection clip for a tent according to claim 1, wherein the connection clip further comprises:
a connecting member for connecting the locking member and the clamping block such that the locking member moves along the first direction to drive the clamping block to move together; and
a guiding member is disposed on the second locking portion and guides the connecting member to move in the first direction;
wherein a guiding hole is disposed on the guiding member, and when the first clamping body and the second clamping body engage to form the clamping cavity, a central axis of the guiding hole is on the same straight line as the first direction; and the connecting member passes through the guiding hole.

6. The connection clip for a tent according to claim 5, wherein the connecting member is a threaded rod, the guiding member is a nut, and the guiding hole is a threaded hole; and the guiding member is fixedly connected to the second locking portion.

7. The connection clip for a tent according to claim 6, wherein the connecting member is rotatably connected to the clamping block, and when the connecting member rotates in the guiding hole, a top surface of the clamping block moves along the first direction while remaining parallel to the top surface of the first clamping body.

8. The connection clip for a tent according to claim 1, wherein the first locking portion is a first cylindrical portion protruding from the first clamping body, the second locking portion is a second cylindrical portion protruding from the second clamping body, and a cross section of the locking assembly formed by cooperation of the first locking portion and the second locking portion corresponds to a cross section of the locking cavity.

9. The connection clip for a tent according to claim 1, wherein the first clamping body is a rectangular frame structure, and the first direction is a diagonal direction of the first clamping body; and each of the first clamping portion and the clamping block is a right-angled structure, and a direction of a rectangular frame formed by abutment of the first clamping portion and the second clamping portion is the same as the direction of the rectangular frame of the first clamping body.

10. The connection clip for a tent according to claim 1, wherein a meshing portion is protrudingly disposed on the first locking portion, a meshing slot is correspondingly disposed on the second locking portion, a first inclined slot is disposed on the meshing portion, and a second inclined slot is disposed on an inner wall of the meshing slot; and when the first locking portion and the second locking portion form an assembly, the meshing portion is embedded in the meshing slot.
